(19) United States
(12) Patent Application Publication
(10) Pub. No.: US 2004/0149235 A1
(43) Pub. Date: Aug. 5, 2004

(54) Apparatus and method for removal of waste from animal production facilities

(76) Inventors: Albert S. Pogue, Nashville, TN (US); David C. Palmer, Franklin, TN (US)

Correspondence Address: Charles W. Calkins, Kilpatrick Stockton LLP, 1001 West Fourth Street, Winston-Salem, NC, 27101, US

(21) Appl. No.: 10/677,096

(22) Filed: Oct. 1, 2003

Related U.S. Application Data
(60) Provisional application No. 60/416,148, filed on Oct. 4, 2002.

(51) Int. Cl. A01K 1/01

(52) U.S. Cl. 119/479

(57) ABSTRACT

An improved apparatus and method of hydraulically removing animal waste from agricultural animal production facility surfaces utilizing a pressurized device and a series of pipes and nozzles joined to a control system designed to optimize the delivery of water needed to remove the waste from the buildings.

Farm operators can use embodiments of the present invention to substantially reduce the volume of water that is currently used to remove waste from the facilities in order to meet mandated waste discharge requirements. Producers will also experience a substantially lower cost of handling and treating smaller waste volumes.

Embodiments of the present invention provide a means to substantially reduce and more cost-effectively treat the high volumes of water that have been traditionally used to remove animal waste from containment structures, thereby helping to reduce the negative environmental impact of concentrated agricultural animal operations.

### CROSS REFERENCE TO RELATED APPLICATIONS

This application claims priority under 35 U.S.C. § 119(e) to U.S. Provisional Patent Application No. 60/416,148, entitled “High-pressure Removal of Waste From Agricultural Animal Production Facilities”, filed on Oct. 4, 2002, hereby incorporated by reference.

### FIELD OF THE INVENTION

The present invention relates to the removal of agricultural animal waste from confinement structures. Embodiments of the present invention provide new apparatus, systems, and methods for transporting waste from the floors of the structures that offer advantages over heretofore used apparatus, systems and methods.

### BACKGROUND OF THE INVENTION

Agricultural animal production operations commonly use very large volumes of re-circulated water to remove waste from animal containment buildings. The wastewater that is used to remove the waste is typically pumped to the buildings from large in-ground lagoons or above ground storage tanks. Historically, the use of big volumes of water has not presented a perceived problem. However, with the tremendous growth of the livestock industry over the last several years, increased water use and the need to land-apply more of the wastewater have become significant environmental issues. Some of the problems resulting from this are: atmospheric emissions of ammonia and greenhouse gasses; nutrient buildup in soils; groundwater and sub-surface aquifer contamination; odor and the existence of pathogens in the effluent.

There are four main types of agricultural animal waste removal systems. One of these is the scrape system, whereby animal waste residues are physically scraped off barn surfaces and transferred directly into a waste-receiving pit. Other water-intensive methods utilize pit-recharge, pull-plug and flush tank systems. This invention improves upon the water-intensive waste removal methods and can be used either to retrofit existing structures or in new building construction.

Both pit-recharge and pull-plug methods use large volumes of wastewater, pumped from waste lagoons, to fill the bottoms of the barns. The animals spend their lives on slatted floors in pens within the barns. Their excrement falls through the slats, into standing water that has been pumped into the barns underneath the slatted floors. The volume of wastewater under the slatted floors is substantial and, for example, is about 50,000 gallons in a 1,000 head swine barn. Periodically the barns are emptied into the waste lagoons. Wastewater from the lagoons is then re-circulated to fill the barns until the next cycle. Waste from the barns is continuously drained and refilled, drained and refilled, creating tremendous odor and emissions problems.

The flush tank method utilizes concrete tanks located at the anterior ends of the barns. They are filled with re-circulated lagoon water and are also periodically emptied, and, using only the force of gravity, attempt to wash the barn floors with the wastewater. The volumes of wastewater the flush tanks can hold are far less than the basements of the pull-plug and pit-recharge barns. Therefore, the flush tanks are repeatedly refilled with water from the lagoons and then emptied again every few hours, thereby repeating the cycle of drain, refill, drain, refill as is done with the other systems, sometimes creating similar and sometimes worse odor and emission problems. Each of these methods leaves a significant odorous and septic sludge residue on the floors of the barns.

Several attempts to deal with these problems have been addressed in the prior art. U.S. Pat. Nos. 4,432,498 to Clements on Feb. 11, 1984; No. 4,208,279 to Varani on Jun. 17, 1980; and No. 4,913,095 to Morrow et al on Apr. 3, 1990, also utilize flush water systems to clean animal barns or houses.

The Clements patent refers to hydraulically processing animal waste including straw and the like bedding material, submerging the bedding material and the waste in a body of water in a container prior to disposal. Duct work supported in the container is connected to a pressurized water source effective to aspirate water and waste into a submerged inlet and conducting it to a place of waste disposal. A jet of pressurized water aids in comminuting the waste, circulating the same past the waste inlet, and in flushing away larger elements tending to obstruct the inlet.

The Varani patent relates to using water to process and remove animal waste products from a pit that comprises a ramp-like lid partially covering the pit to seal the contents from the atmosphere. The ramp is used to direct the waste into the lower end of the pit, where a heater prevents its freezing. The pit beneath the floor is, itself, used as a biological treatment device. Fresh waste entering the pit pushes the treated waste from the pit.

The Morrow, et al. patent relates to a system having large-volume reservoir adapted to quickly flush a large quantity of water to clean the sub-floor of a hog house or similar animal pen. The reservoir preferably comprises a box-like tank having four spaced-apart side walls, and is preferably positioned above ground upon a hollow foundation adjacent the hog house or houses which it services. A multiplicity of water output orifices defined through the floor of the tank in spaced-apart alignment feed into a system of subsurface conduits or pipes which channel into appropriate inlets in the sub floor of the animal pen.

All of the aforementioned patents utilize large quantities of water to flush animal waste from the pit below the animals. The resulting sludge from these operations forms dilute slurry of animal waste suspended in water. These slurries must then be transported to a traditional lagoon or otherwise treated to remove the biologically harmful components. Treatment of large quantities of water-heavy animal waste sludge involves large capital costs for the treatment facilities as well as on site storage of the waste awaiting treatment.

In conclusion, there are no barn or farm waste removal systems that provide the hydraulic flexibility, lower water usage, and automatic and programmable controls to adapt both existing and new agricultural animal production facilities.

Prior animal waste removal systems have not combined advantages of low water waste removal that reduces the overall quantity of treatment intensive animal waste that overcome disadvantages of the high capital cost associated with such treatment. Furthermore, current systems have failed to minimize the odor associated with hydrogen sulfide compounds in the manure and ammonia causing acids in the urine.

It would, therefore, be desirable to minimize these issues through the means to use substantially lower volumes of water needing treatment or land-application, thoroughly cleaning the barn floors with the high-pressure force of pumps, pipes and nozzles, reducing odors and emissions and providing a more economical method for farm operators to remove and treat waste from the facilities.

Thus, there is a need to provide a system and method for removing animal waste from pens or pits that uses a minimal amount of water and where the residual sludge from the removal process is amicable to current low-cost treatment processes. Preferably, the system would be adaptable to current animal housing facilities without the need for major reconstruction.

It is to these perceived needs and desires that the present invention is directed.

### SUMMARY OF THE INVENTION

In a first aspect of the present invention an apparatus for removal of waste from animal production facilities is provided. The apparatus comprises a plurality of transmission channels each comprising an inlet at one end connectable to a pressurized fluid source, and plurality of apertures thereon, wherein the transmission channels are capable of delivering pressurized fluid to said apertures for release into the containment structure. The inlets of the transmission channels are connected to a pressurized conveyance means for delivering pressurized fluid to said transmission channels. The pressurized conveyance means is fluidly connected to the pressurized fluid source and the pressurized fluid source comprises a pump and/or a valve for regulating flow to the pressurized conveyance means. The apparatus further comprises a control means for controlling the pressurized fluid source, and the transmission channels further comprise valves capable of regulating fluid flow therethrough.

In another aspect of the present invention, a method for removal of waste from animal production facilities is provided. The method comprises: providing a plurality of transmission channels each comprising an inlet at one end and a plurality of apertures thereon; forcing pressurized fluid through said transmission channels and said apertures such that the fluid is forcefully ejected from said apertures; a pressurized conveyance means functionally connected to said transmission channels, wherein the pressurized conveyance means provides pressurized fluid to the transmission channels; a pressurized fluid source functionally connected to said pressurized conveyance means, and a control means for regulating the flow of fluid from said pressurized fluid source to said pressurized conveyance means.

The method further comprises providing a control means to control the delivery of pressurized fluid to the transmission channels and programming the control means to periodically deliver pressurized fluid to the transmission channels according to a predetermined optimal pattern.

Additionally, the method comprises allowing the water ejected from said apertures to contact and mix with animal waste within the containment structure to form an effluent stream, and removing said effluent from the containment structure. The resultant effluent stream produced by the method of the present invention may then be treated to remove biologically harmfully residues. The method of the present invention further facilitates recycling the treated effluent stream by introducing it into the pressurized fluid source.

The system and method for the removal of animal waste of the present invention provides numerous features and advantages over prior methods and apparatus. For example, the present invention advantageously provides a means for removing animal waste in the waste pit of an animal housing facility using high pressure water at predetermined intervals to reduce the total quantity of water necessary to remove a given amount of waste.

One feature and advantage of the present invention is that the delivery network can be customized to fit a variety of barn designs and configurations.

Another feature and advantage of embodiments of the present invention provides programmable controls that are designed to adjust the waste removal system to meet the changing conditions and growth cycles of animals both within the barns and between the barns. This invention allows farm operators to systematically and automatically control the amount of hydraulic load (pressure, location and flow rates) needed to remove varying amounts of waste from animal barns and houses under dynamic conditions.

A further feature and advantage of the present invention is the economical and environmentally superior design of the apparatus for both retrofits of existing structures, new construction and varying barn and farm sizes. Embodiments of the present invention can be used to retrofit existing structures no matter what the barn design, size or configuration, as well as in new barn construction.

The embodiments of the present invention can operate successfully either using current waste disposal practices or with new, more sophisticated, environmentally superior waste treatment systems.

A still further feature and advantage of the present invention is the automatic, high-pressure waste removal system uses significantly less water than current barn cleaning methods, thereby resulting in lower volumes of waste effluent needing treatment and land application.

In addition to water savings, a feature and advantage of the present invention is the reduction in barn odor and emissions by the frequent removal of odor-causing hydrogen sulfide compounds in the manure and ammonia-causing acids from the urine, while maintaining a low-water usage as compared to prior art methods.

An additional feature and advantage of the present invention is the reduced cost-per-animal associated with treatment of effluent wastewater from the barns, making the present invention affordable for all farms.

The features and advantages of the present invention provide a system that can precisely control the amount, frequency and duration of the flushing, thereby ensuring a uniform flow and loading to an effluent treatment process. By its nature, the apparatus is especially useful in biological process such as anaerobic digestion where the system requires a specific hydraulic retention time for its performance. By lowering the amount of water entering the biological process, a significant reduction in the size, and therefore the cost, of tankage, pipes and pumps results. As an example, an aerobic digester requiring 20 days hydraulic retention time could be five times smaller with the device compared to traditional flushing methods.

As will be realized by those of skill in the art, many different embodiments of an apparatus and method according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is an isometric view of a waste removal apparatus of an embodiment of the present invention shown within the confines of a waste pit.

FIG. 2 is a cross sectional view of an animal shed or barn including the waste removal system of an embodiment of the present invention.

FIG. 3 is an isometric view of the waste removal system shown in FIG. 2.

### DETAILED DESCRIPTION

In a first aspect of the present invention an apparatus for high-pressure, low-water usage removal of animal waste is provided. The apparatus is specifically designed to minimize the amount of water used in the waste removal process as compared to the currently employed systems described in the “Background” section of this specification. The apparatus generally comprises a pressurized conveyance means to bring water to a plurality of transmission channels each comprising a plurality of apertures for forcefully releasing the water into the surrounding environment.

The terms “water”, “fluid”, and “liquid” are used interchangeably throughout this specification to refer to the fluid used to wash the animal waste from the pit. Generally the water used in such a system comprises re-circulated or treated water that has been previously used in the waste removal process, treated, and returned to the system. It should be recognized that other liquids or mixtures of water and other liquids, such as anti-odor agents may also be employed.

The apparatus of the present invention is capable of use in conjunction with a variety of existing animal housing structures. Often cattle and pigs are raised in a building which is structurally minimal, consisting of a slotted flooring over a pit to allow waste to fall through the floor and into the pit. Some facilities have solid walls and temperature control mechanisms, while others comprise fencing or bars to retain the animals with a shed roof provided overhead to protect from sunlight and rain or snow. The particular design is often dictated by the needs of the animal being housed and the climatic conditions of the area. The present invention may be employed with any type of animal housing structure comprising a waste collection area that needs periodic cleaning. The most abundant example of such a waste collection area is the pit mentioned above, and as such will be used as an example throughout this specification.

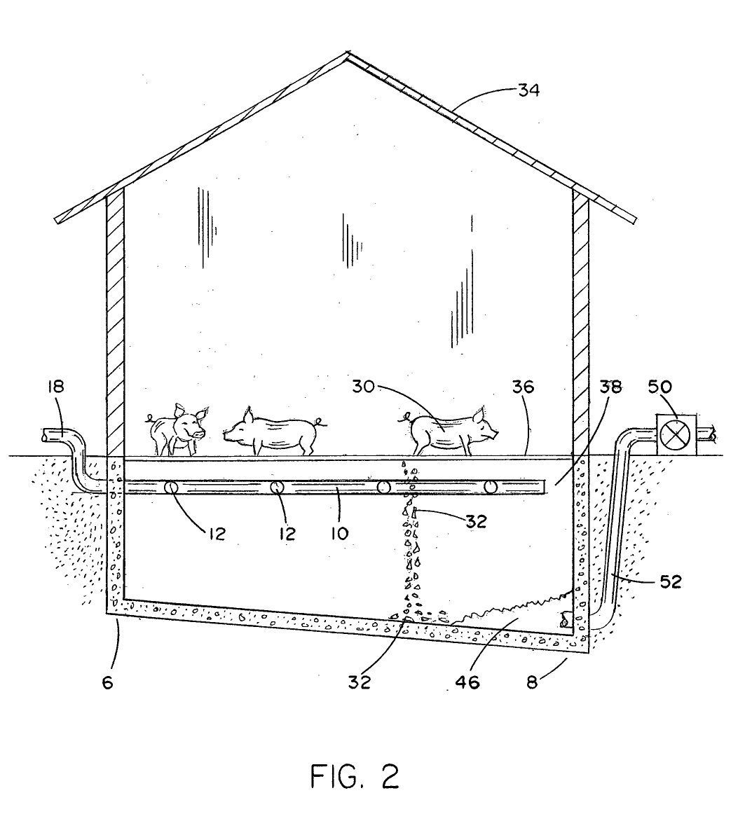

In a classic pit configuration, a cement-lined pit with a sloping bottom lies a distance under the slotted flooring of a barn. The bottom of the pit is angled to facilitate drainage of the waste products to a lower end for collection and removal. As seen in FIG. 2 the bottom of the pit 38 comprises a high end 6 and a low end 8. Other well-known embodiments of a waste pit comprise a pit with high sides and a low trough down the middle, or other configurations comprising at least one higher portion and a at least one lower portion. In any of the aforementioned configurations, a means for draining waste from the pit is generally located at or near the lowest point. The embodiment shown in FIG. 2 illustrates a pipe 52 and pump 50 for removing the effluent 46 that has collected at the low end 8 of the pit. The effluent 46 is then transported to a lagoon or other storage or treatment area.

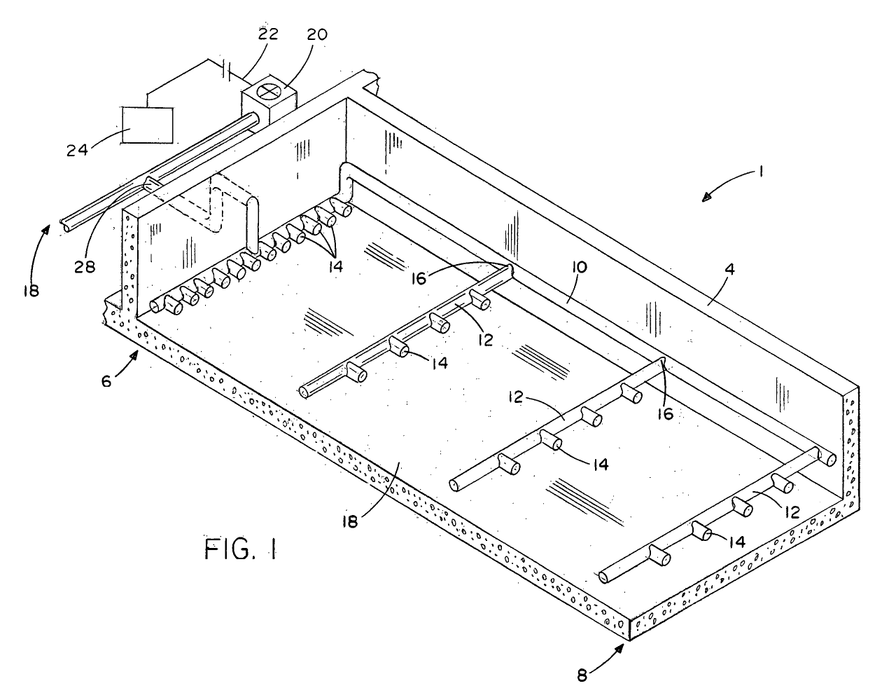

As shown in FIGS. 1 and 2, an embodiment of the waste removal apparatus 1 of the present invention is employed within a pit 38 under the floor 36 of a barn 34. As the animals 30 generate waste 32, it falls through the slotted floor 36 and collects in the bottom of the pit 38. The apparatus is configured to effectively provide high-pressure water to wash the waste 32 from the bottom of the pit 38 and collect as an effluent 46 at the lowest point within the pit 8.

The apparatus 1 comprises a plurality of transmission channels 12 placed at predetermined intervals throughout the pit 38. Each transmission channel 12 further comprises a first end 16 and a plurality of apertures 14. The first end 16 is functionally connected with a pressurized conveyance means 10 that is in turn functionally connected to a pressurized fluid source 18. The pressurized fluid source 18 delivers pressurized fluid to the pressurized conveyance means 10 which in turn deliver the fluid to the transmission channels 12 for deployment through the apertures 14.

In a preferred embodiment of the present invention, each of the transmission channels 12 comprises a pipe such as poly vinyl chloride (PVC) or other non-corrosive material. The plurality of transmission channels 12 are interspersed at predetermined positions throughout the pit 38. The number of transmission channels 12 and their proximity to each other will depend upon factors such as, the type of animal being housed within the barn, the number and design of the apertures 14 along the transmission channels, as well as the amount and pressure of water used. Further, though the transmission channels 12 in the figures are shown in a symmetrical design, it is envisioned that certain applications will require transmission channels 12 of varying length throughout the pit.

In a preferred embodiment of the present invention, the transmission channels 12 and therefore the apertures 14 are located near the top of the pit 80, just below the barn floor 36, as shown in FIG. 2. This ensures a uniform flow over the animal waste 32 and reduces or eliminates clogging and buildup of waste 32 on the apparatus, which could interfere with the high-pressure spray.

In alternate embodiments of the present invention, the transmission channels 12 are located along the bottom of the pit or raised from the bottom a predetermined distance, depending upon the particular design configuration and needs of the particular use.

The size and location of the apertures 14 along the transmission channel 12 will vary according to the particular design criteria of the intended use. For example, based on the intended use, it may be more desirable to have fewer larger apertures along the transmission channel 12 rather than a greater number of smaller apparatus 12. Generally, the apertures 14 are positioned along the transmission channel 12 so as to provide a sufficient stream of pressurized water along the length of the transmission channel 12 to effectively wash away the animal waste along the bottom of the pit.

In one embodiment of the present invention, the apertures 14 comprise holes in the wall of the transmission channel 12 to allow fluid to flow therethrough. However, in a preferred embodiment of the present invention, the apertures 14 comprise nozzles or short extensions of pipe extending from the transmission channel 12. The nozzles preferably comprise brass, stainless steel, or other non-corrosive materials and may be positioned and directed to maximize the effectiveness of their corresponding high-pressure water stream.

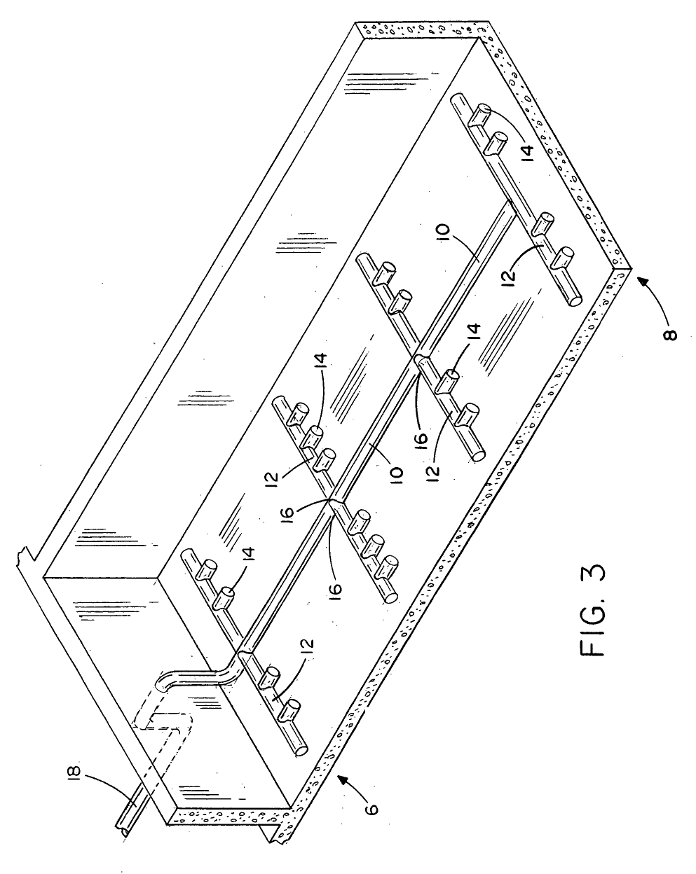

The apertures 14 and transmission channel 12 are supplied with high-pressure water via a pressurized conveyance means 10. In a preferred embodiment of the present invention, the pressurized conveyance means 10 comprises a pipe or other conduit. In the embodiment shown in FIG. 1 the pressurized conveyance means 10 is located along the pit wall 4. In an alternate embodiment of the present invention, shown in FIG. 3, the pressurized conveyance means 10 is located along the interior of the pit 38, so as to provide pressurized water to transmission channels 12 extending from multiple sides in opposite directions.

In a preferred embodiment of the present invention, the apparatus, including the pressurized conveyance means 10, and transmission channel 14, are secured to the walls and/or floor of the pit. Given the hydrodynamic pressure exerted on piping systems in high-pressure applications, it is advantageous to secure the component parts to prevent movement during operation. This is facilitated when the apparatus of the present invention is installed during construction of the pit. In this manner, the pressurized conveyance means 10 is imbedded in the concrete during construction. Similarly, the transmission channels are adaptable to be inlaid in the concrete pit bottom with the apertures 14, preferably nozzles, extending to the surface. In addition to securing the component parts from moving during use, enclosing them within the walls of the pit also prevents corrosion and wear of the parts, thereby extending time between maintenance.

In a preferred embodiment of the present invention, the pressurized fluid source comprises at least one of a pump 20 provided to boost the water pressure, and a valve 28 to further regulate flow into the pressurized conveyance means 10. In embodiments of the present invention comprising a plurality of barns each employing the apparatus of the present invention, a centralized pump 20 or pumping station provides pressurized water to all of the barns. A valve 28 associated with each individual barn then regulates pressure and flow into that particular barn, depending on the needs of that barn.

In a further embodiment of the present invention, any of the pumps 20 or valves 28 may be controlled through a control means 24 to regulate water pressure and flow rate through the apparatus. In this manner, the pressure and flow rate, as well as timing of water delivery may be precisely controlled depending on the particular needs of the barn. As the type of animal or stage of development of the animals housed within the barn changes, so will the quantity and frequency of pit cleaning.

In a preferred embodiment of the present invention, the control means 24 comprises an automatic control system, such as a computer or timing device, capable of being programmed to electronically and mechanically control the assemblage of pumps and valves. The control means 24 may advantageously be located in a centralized office for the farm or animal production facility and communicate with the assemblage of pumps 20 and valves 28 through a communication means 22 such as wiring or radio transmissions. In this way the control means 24 operates to regulate the volume, flow rate, and pressure of water entering the apparatus of the present invention. By precisely controlling the timing of water flow, and only cleaning the pit in predetermined intervals, the quantity of water used is minimized while maintaining a cleaner, and reduced odor producing pit.

This configuration of the apparatus of the present invention lends itself well to multiplicity within a system of animal housing comprising multiple sheds or barns dispersed throughout a farm. In one embodiment, a centralized pressurized water source and control means provides pressurized water to all barns. Though a centralized control is desirable, a series of valves or pumps corresponding to each barn will facilitate separate control for each barn to ensure proper timing and water conservation based on the particular needs of the individual barn and the livestock contained therein.

In another aspect of the present invention, a method for removing animal waste from a containment structure is provided employing the apparatus disclosed herein. Given the description and disclosure of the apparatus of the present invention, the method is readily apparent. First, the apparatus of the present invention comprising a system of pressurized conveyance means 10, transmission channels 12 and apertures 14 is provided within the pit of an animal housing facility 34. Second, a pressurized fluid source 18 is provided and functionally connected to the apparatus. Then, at predetermined intervals, high-pressure water is allowed to flow from the pressurized fluid source 18 into the apparatus and is discharged through the apertures into the pit. The pressure and flow rate of the water is determined so as to wash away a desirable quantity of animal waste 32. An effluent waste sludge 46 collects at the low end 8 of the pit 38. This effluent 46 is then pumped or otherwise removed from the pit to be transported to a treatment or storage facility.

In a preferred embodiment of the present invention, the effluent is treated through anaerobic digestion of the organic matter and other commonly known treatment methods. The treated water is then delivered back to the system through the pressurized fluid source. In this manner, a quantity of water may be reused by the system and method of the present invention contributing to a reduction in contaminated runoff from the facility.

In one embodiment of the present invention, operators use the control means 24 to program or otherwise control the pressurized waste removal system to automatically and systematically remove waste from the barns at various intervals. Additionally, different flow and pressure rates are utilized based on the specific, dynamic conditions in the barns during the growth cycle of the animals. For example, less water is needed to remove waste when the animals are smaller, and more water is needed as the animals grow to market weight. This is a result of the amount of waste generated by the animal increasing with the animal's size. The system can be manually over-ridden and operated in times of system maintenance, repair or under other abnormal circumstances.

### EXAMPLE

An exemplary embodiment of the apparatus and method of the present invention will now be described with regard to a swine farm comprising a barn with four pits or channels below the barn. This example has been provided for illustrative purposes and in no way is meant to limit the scope of the invention.

The system installed at the swine farm uses approximately 80 psi water pressure. The piping system is designed to minimize pressure drop to assure that a uniform pressure is supplied to each nozzle. The water usage of each row of nozzles is designed for its location in the barn, i.e. greater flows initially and tapering to the last row. The total amount of flow through the nozzles is 250 gallons per minute per channel. Each barn contains four channels.

The system is designed to allow for greater flushing times for the barns containing the largest animals. The system may be employed one minute per day for the barns with fifty pound animals and four minutes for barns with two hundred and fifty pound animals. The system can be tailored by channel so that one channel may be flushed less than an adjacent channel in the same barn.

The farm receives animals for two barns at a time and has animals on-site that weigh from 50 pounds to 250 pounds. Based on the average size of animals in the barns, the system will be operated twice per day for a total of 120 minutes, resulting in a total daily flow of thirty thousand gallons. Each barn will be flushed twice per day with the smaller animals' flushing time being two minutes per day and the larger animals' flushing time being sixteen minutes per day. Flushing is regulated through automated valves and an automated control system to monitor and operate the valves.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

What is claimed is:

1. An apparatus for the removal of animal waste from containment structures, comprising:
a plurality of transmission channels each comprising an inlet at one end connectable to a pressurized fluid source, and plurality of apertures thereon, wherein the transmission channels are capable of delivering pressurized fluid to said apertures for release into the containment structure.

2. The apparatus of claim 1 wherein the inlets of said transmission channels are connected to a pressurized conveyance means for delivering pressurized fluid to said transmission channels.

3. The apparatus of claim 2 wherein said pressurized conveyance means is fluidly connected to the pressurized fluid source.

4. The apparatus of claim 1 wherein said pressurized fluid source comprises a pump.

5. The apparatus of claim 1 wherein said pressurized fluid source comprises a valve.

6 The apparatus of claim 1 further comprising a control means for controlling the pressurized fluid source.

7. The apparatus of claim 1 wherein said transmission channels further comprise valves capable of regulating fluid flow therethrough.

8. A method of removing animal waste from containment structures using the periodic release of high-pressure fluid comprising:
providing a plurality of transmission channels each comprising an inlet at one end and a plurality of apertures thereon; and,
forcing pressurized fluid through said transmission channels and said apertures such that the fluid is forcefully ejected from said apertures.

9. The method of claim 8 further comprising a pressurized conveyance means functionally connected to said transmission channels, wherein the pressurized conveyance means provides pressurized fluid to the transmission channels.

10. The method of claim 9 further comprising a pressurized fluid source functionally connected to said pressurized conveyance means, and a control means for regulating the flow of fluid from said pressurized fluid source to said pressurized conveyance means.

11. The method of claim 10 further comprising providing a control means to control the delivery of pressurized fluid to the transmission channels.

12. The method of claim 11 further comprising programming the control means to periodically deliver pressurized fluid to the transmission channels according to a predetermined optimal pattern.

13. The method of claim 8 further comprising:
allowing the water ejected form said apertures to contact and mix with animal waste within the containment structure to form an effluent stream; and
removing said effluent from the containment structure.

14. The method of claim 11 further comprising recycling the treated effluent stream by treating the effluent to remove biologically harmfully residues and re-introducing the stream into the pressurized fluid source.
